(19) United States
(12) Patent Application Publication
(10) Pub. No.: US 2017/0305179 A1
(43) Pub. Date: Oct. 26, 2017

(54) DECORATIVE PRINTING PROCESS

(71) Applicant: SUN CHEMICAL CORPORATION, Parsippany, NJ (US)

(72) Inventors: Yuemei ZHANG, Ramsey, NJ (US); Philippe SCHOTTLAND, Sparta, NJ (US)

(73) Assignee: SUN CHEMICAL CORPORATION, Parsippany, NJ (US)

(21) Appl. No.: 15/517,610

(22) PCT Filed: Oct. 16, 2015
(86) PCT No.: PCT/US2015/055937

§ 371 Date: Apr. 7, 2017

Related U.S. Application Data
(60) Provisional application No. 62/065,228, filed on Oct. 17, 2014.

(51) Int. Cl. B41M 7/00; B32B 33/00; B44F 1/00; B44C 5/04

(52) U.S. Cl. CPC B41M 7/009; B44F 1/00; B44C 5/0469; B41M 7/0081; B32B 33/00; B32B 2451/00; B32B 2255/28; B41M 2205/40

(57) ABSTRACT

The present invention provides a process for manufacturing a decorative article, typically in the form of a sheet or web, by providing the substrate with a pore pattern layer which is then dried using a first energy curable water-based ink or coating composition which is essentially free of a curing or cross-linking agent and contains a repellant and subsequently applying a topcoat layer over the pore pattern layer using a second energy curable water-based ink or coating composition which is also essentially free of a curing or cross-linking agent.

### CROSS REFERENCE TO RELATED APPLICATIONS

This application claims priority to U.S. Provisional Patent Application Ser. No. 62/065,228 filed Oct. 17, 2014, which is hereby incorporated herein by reference in its entirety and for all purposes.

### FIELD OF THE INVENTION

The present invention is directed to a process for producing printed decorative articles, and in particular decorative paper, that avoids the use of organic solvents and curing agents and which provides an article that exhibits enhanced durability upon curing with energy curing radiation, such as electron beam (EB) radiation.

### BACKGROUND OF THE INVENTION

The present invention relates to printed decorative materials having a three dimensional or embossed effect suitable for use as a residential interior material or a furniture surfacing material.

JPB 89/17427 discloses printing a pore pattern on a substrate using a curable ink composition containing a repellent. Subsequently a thermosetting paint is coated thereon. Upon heating the paint is repelled from the areas where the curable ink composition has been applied, thereby forming concavities. However, the ink and paint compositions used herein are oil-based and the organic solvents contained therein are not environmentally friendly.

U.S. Pat. No. 5,665,457 discloses a similar process that uses a water based ink/coating system but employs inks that contain a curing agent which are often toxic such as epoxy or aziridine to generate cross-linked structure for good durability. Furthermore these curing agents can induce in-pot curing and adversely affect in-pot stability.

U.S. Pat. No. 4,196,033 and U.S. Pat. No. 8,313,824 disclose a means to form an embossed or three-dimensional effect on a decorative paper, using a thermosetting impregnating resin and forming the paper on a shaping member under elevated temperature.

U.S. Pat. No. 7,131,380 discloses a means to achieve a patterned effect, particularly profile ridges, in a printed substrate, utilizing a low surface tension electron-beam-curing coating that can be patterned and subsequently printed over, generating a ridged effect.

Finally U.S. Pat. No. 5,019,202 discloses a means to generate an embossed effect using a blocked curing agent or polymerization catalyst and a curing resin.

### SUMMARY OF THE INVENTION

The present invention provides a process for the production of a decorated article comprising the steps of:
a) printing a first energy curable water-based ink or coating composition onto a substrate to provide a pore pattern layer thereon;
b) drying the pore pattern layer;
c) printing a second energy curable water-based ink or coating composition onto the pore pattern layer to provide a topcoat layer thereon;
d) drying the topcoat layer and
e) energy curing the printed substrate to provide a cross-linked structure
   wherein at least one of the first ink or coating composition or the second ink or coating composition contains a repellant and wherein at least one of the first ink or coating composition or the second ink or coating composition does not contain a curing agent.

Furthermore the present invention provides a decorated article, particularly in the form of a sheet or a web produced the process of the present invention.

These and other objects, advantages, and features of the invention will become apparent to those persons skilled in the art upon reading the details of the methods and formulations as more fully described below.

### BRIEF DESCRIPTION OF THE DRAWING

FIG. 1 is a sectional view of printed decorative article produced by the process according to the present invention.

### DETAILED DESCRIPTION OF THE INVENTION

The present invention is directed to providing a substrate, typically a paper sheet, web or roll with a three dimensional decorative surface without the use of toxic solvents and curing agents.

The process typically involves providing a substrate with a printed design layer which is then usually dried. A pore pattern layer is then printed onto the printed design layer using a first energy curable water-based ink or coating composition which is essentially free of a curing or cross-linking agent and advantageously contains a repellant.

In particular, the present invention avoids the use of curing agents such as aziridines, melamines, formaldehyde, melamine-formaldehyde, epoxies, anhydrides, amines, amides, carbodiimides, isocyanates, mercapto compounds, silanes, Michael addition reaction materials and Diels-Alder reaction materials.

Furthermore, wherein the present invention comprises UV-curable inks, the inks will typically contain radical photoinitiators and/or cationic photoinitiators to initiate free radical curing upon exposure to UV light. Radical photoinitiators and cationic photoinitiators would not be considered as curing agents as those discussed herein above.

Additionally, curing agents that the present invention also excludes are blocked acids.

The pore pattern layer is then dried prior to applying a topcoat layer thereon.

The topcoat layer is provided by a second energy curable water-based ink or coating composition which is also advantageously essentially free of a curing or cross-linking agent and may also contain a repellant.

The pore pattern layer and the topcoat layer may have different gloss levels which accentuates the three dimensional effect. In particular, the topcoat layer may be highly glossy whilst the pore pattern layer is matte or visa versa.

The printed design layer, the pore pattern layer and the topcoat layer are typically heat dried or dried by infra-red radiation.

In particular, the pore pattern layer is not energy cured and preferably the topcoat layer is not energy cured.

The layers are advantageously dried such that the layer is dry to the touch of a finger (the so-called ‘touch dry’ state, well known to those skilled in the art).

This may also be considered a dry tack-free state which is the stage of drying that when the ink or coating composition is lightly touched it no longer feels sticky or tacky.

It has been found that by drying the pore pattern layer as herein described above prior to applying the topcoat layer ensures that the topcoat layer positioned in the pores of the printed pore pattern layer is repelled and thus forms concavities over the substrate surface upon drying as herein described above.

Furthermore prior to printing the pore pattern layer onto the substrate a printed design layer may be printed thereon and the pore pattern layer is printed onto the printed design layer. Advantageously, the printed design layer imitates the grain of wood.

Typically, the printed design layer is water-based, solvent-based, a hot-melt, a powder and/or energy-curing and is dried as herein described above prior to the pore pattern layer being printed thereon.

Additionally a third ink or coating composition may be applied onto the dried topcoat layer and may be a water based, solvent-based, a hot-melt, a powder and/or energy-curing ink or coating composition.

Finally the complete printed substrate is energy cured with advantageously a single exposure of electron beam (EB) radiation or actinic radiation to provide an essentially a cross-linked structure. Consequently, this removes the need for energy cure between the two printing stations and thus saves energy.

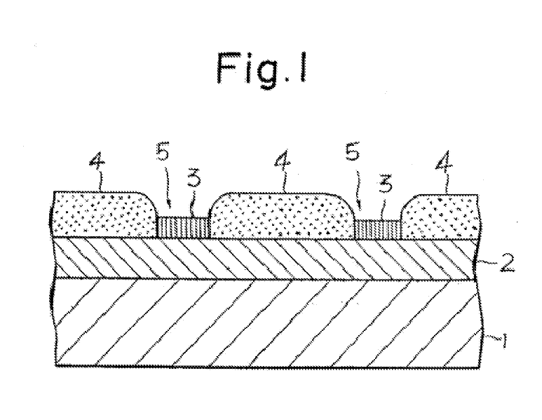

FIG. 1 is a sectional view of a decorated article as produced by the process according to the present invention. As shown, the decorated article comprises a substrate [1], a printed design layer [2], a pore pattern layer [3], a topcoat layer [4], and concavities [5] that are formed as the result of repellency of the topcoat [4] in the areas where the pore pattern layer [3] is formed.

The pore pattern layer [3] and the topcoat layer [4] are formed from energy curable water-based ink or coating compositions whereas the printed design layer [2] may be formed from any type of ink or coating composition which may be a water-based, a solvent-based, energy curable or a hybrid ink or coating composition.

The water-based ink or coating compositions may be water-dispersible or water-soluble.

Additional ink and/or coating composition layers may be deposited onto the topcoat layer [4]. These additional layers may be produced using any type of ink or coating composition which may be a water-based, a solvent-based, energy curable or a hybrid ink or coating composition.

Furthermore additional primer layers may be deposited beneath or on top of the printed design layer. Once again these primer layers may be produced using any type of ink or coating composition which may be a water-based, a solvent-based, energy curable or a hybrid ink or coating composition.

The substrate [1] is typically in a sheet or web form and is preferably manufactured from any material that is commonly used to form the base paper of decorative paper, including, for example, tissue paper, resin mixed paper and resin impregnated paper that has a basis weight of between about 10-100 g/m².

Alternatively, the substrate may be manufactured from other materials such as plastic films, woven and non-woven materials, and metal foils.

Preferably, the substrate is a paper substrate, advantageously a black iron oxide impregnated paper substrate.

Typically, the printed design layer [2] will be a water-based ink or coating composition that employs a vehicle such as an aqueous acrylic resin which is kneaded with a colorant and various other additives, as well as diluent water.

Preferably, in order to mask the color of substrate [1], a suitable colored ink is applied to the surface of the substrate prior the application of the printed design layer.

Alternatively, for the purpose of closing small holes in the surface of substrate [1] and improving its adhesion, a water-based sealer layer (water-based undercoat layer) may be formed on substrate [1] prior the application of the printed design layer.

The energy curable water-based ink or coating composition applied to form the pore pattern layer [3] comprises of an energy curable vehicle that is mixed with diluent water, as well as a repellent and various other additives.

Typically, the topcoat layer [4] may also contain various additives, such as silicone, wax, fluorocarbon wax or resin.

Advantageously, the pore pattern layer and the topcoat layer comprise a polymer or resin having a cross-linkable ethylenically unsaturated group.

The pore pattern layer and the topcoat layer typically comprise a resin or polymer selected from the group consisting of polyurethanes, polyurethane-polyureas, polyesters, polyamides, polyester-epoxies, epoxies, acrylics, methacrylics, styrenics, copolymers of styrene and maleic anhydride, polyvinyl alcohol, polyvinyl acetate, polyvinyl chloride copolymers, cellulosics, and combinations thereof.

Advantageously, the first ink or coating composition and/or the second ink or coating composition comprises an aqueous polyurethane dispersion.

Typically, the first ink or coating composition and/or the second ink or coating composition comprises between 80 to 98 wt % of resin.

The repellent is typically a surface tension modifying additive and may include materials such as silicone resins, polyethylene waxes, polytertafluoroethylene (PTFE) waxes, fluorocarbon resins and waxes and are preferably waxes, especially paraffinic and petroleum-derived waxes and natural waxes such as montan, lanolin, carnauba and/or candellila waxes. Fluorocarbon waxes and resins are preferred.

In particular, the waxes may be used in micronized form or in the form of an aqueous dispersion.

Advantageously, the first ink or coating composition contains a paraffin wax and/or natural wax, whilst the second ink or coating composition comprises a polyethylene and/or a polytetrafuoroethylene (PTFE) wax.

The repellent may be preloaded as an aqueous emulsion in the ink or coating composition or, alternatively, it may be incorporated into the ink or coating composition just before use.

The repellent is usually present in the amount of between 2 to 20 wt %, preferably between 8 to 16 wt % and advantageously between 10 to 14 wt % of the ink or coating composition.

Each ink or coating composition layer preferably has a surface tension in the wet state and a surface energy after drying of between 24-54 dyne/cm. Most preferably, the ink or coating compositions will have a surface tension within + or −5 dynes/sq. cm of the dried coating it is to be printed or coated over.

The layers may be applied by a coating or printing process selected from the group consisting of flexography, gravure, roll coating, reverse roll coating, anilox, lithography, spray coating, powder coating, electrodeposition, hot melt, screen printing, pad printing, tampon printing, xerography, elcography, ink jet, dip coating, cascade coating, slot coating, air knife coating, curtain coating and trough coating.

Typically, the printed pore pattern layer [3], may be applied to the substrate by any known printing technique such as inkjet, flexographic, gravure, screen, pad and lithographic printing.

The topcoat [4] may be applied by any customary coating techniques including, for example, roll coating, gravure coating, flexographic coating, bar coating, die coating, air-knife coating, flow coating, curtain coating, spin coating, spray coating, cascade coating and dip/trough coating.

Additionally the topcoat layer [4] is preferably applied to the entire surface of the underlying layers including the pore pattern layer [3], and thereafter dried by heating with the temperature being varied stepwise.

The invention is further described by the examples given below.

### EXAMPLES

### Example 1: Preparation of a Decorative Article According to the Present Invention

A surface of a black iron oxide impregnated paper substrate was subjected to overall gravure printing with a water-based ink and heat dried to a tack-free/touch dry finish. Then, a printed design layer imitating the grain of wood was gravure printed with a water-based ink and heat dried to a tack-free/touch dry finish.

In the next step, a pore pattern layer was gravure printed onto with the printed design layer using the coating composition set out in Table 1 and dried to a tack-free/touch dry finish.

TABLE 1
Water based energy curable repellent coating

| Material | % |
|---|---|
| Neorad R465 (IGM resin) | 88 |
| Aquabead 525E (blend of paraffin | 12 |
| and natural wax) | |
| BYK016 (BYK) | 0.2 |
| Total | 100.0 |

Subsequently, an electron beam curable water-based topcoat of the formula shown below in Table 2 was gravure coated on the entire surface to give a deposit of 6 g/m² on a dry basis and dried to a tack-free/touch dry finish.

TABLE 2
Water-based energy curable topcoat

| Material | % |
|---|---|
| Neorad R465 (IGM resin) | 97.0 |
| Polyfluo411 (wax) | 2.5 |
| BYK1719 (defoamer) | 0.5 |
| Total | 100.0 |

As a result the topcoat layer in the areas where the pore pattern was formed was repelled to provide a concave surface having a good aesthetic appeal. The printed decorative paper as the final product had a concave pore pattern in register with the grained design.

As a final curing step, the entire printed substrate was subjected to EB curing.

The finished printed substrate exhibits improved solvent resistance when compared to the current industry standard as measured using methyl ethyl ketone (MEK) double rubs—see Table 3.

TABLE 3
Solvent resistance of Example 1 vs. Comparative Industry Standards

| | | Liochem Repellant Ink + | |
|---|---|---|---|
| | Example 1 | 1% Liochem Epoxy | Liochem Repellant |
| | (Inventive) | Crosslinker | Ink w/o Crosslinker |
| MEK | 20 | 15 | 5 |
| Double | | | |
| Rubs | | | |

Coatings were printed side by side using K-coater Kbar#2 at speed 7. Coated prints were heated at 150° C. oven for 45 seconds to insure the curing of the water based coatings and then passed through electron beam at 30 KGY dosage, 101 KV voltage, 3.7 mA and 50 fpm.

The present invention offers the following advantages:

First, the use of water-based coating solutions and inks eliminates the health and environmentally problems associated with the use of organic solvents in the prior art. As a result, the required large-scale exhaust facilities are obviated and one can produce environmentally friendly printed decorative paper.

Secondly, being produced with water-based resin, preferably, with ethylenically unsaturated double bond, the coatings can be further cross-linked without using any toxic curing agent (such as those containing aziridine or formaldehyde), and the printed decorative paper of the invention has sufficient resistance to water, oil, detergent, and scratching, and it is also stain resistant from coffee, tea, ketchup, mustard, and other staining materials well-known to those skilled in the art, and exhibits better MEK (methyl ethyl ketone) resistance (as representative of resistance to common solvents such as ethanol, gasoline and paint thinners) so that it has enhanced durability for use as an interior decor material. Tests were carried out as described in ANSI “NEMA Standards Publication LD 3-2005”—sections 3.4 and 3.7.

TABLE 4
Product Resistance Results.

| Example 1 | Results |
|---|---|
| Scratch - 200 grams | 0 |
| Water | 0 |
| Vegetable Oil | 0 |
| Catsup | 0 |
| Mustard | 0 |
| Coffee | 0 |
| Tea | 0 |

0 = no removal

The above examples are drawn to an EB curing embodiment, but it is understood that other means of energy cure are also within the scope of the present invention, including UV cure, which requires the addition of photoinitiators, which is well known in the art.

While the present invention has been described with reference to the specific embodiments thereof, it should be understood by those skilled in the art that various changes may be made, and equivalents may be substituted, without departing from the true spirit and scope of the invention. In addition, many modifications may be made to adapt a particular situation, material, composition of matter, process, process step or steps, to the objective, spirit and scope of the present invention. All such modifications are intended to be within the scope of the invention.

1. A process for the production of a decorated article comprising the steps of:
a) printing a first energy curable water-based ink or coating composition onto a substrate to provide a pore pattern layer thereon;
b) drying the pore pattern layer;
c) printing a second energy curable water-based ink or coating composition onto the pore pattern layer to provide a topcoat layer thereon;
d) drying the topcoat layer; and
energy curing the printed substrate to provide a cross-linked structure wherein at least one of the first ink or coating composition or the second ink or coating composition contains a repellant and wherein at least one of the first ink or coating composition or the second ink or coating composition does not contain a curing agent.

2. A process according to claim 1, wherein both the first ink or coating composition and the second ink or coating composition do not contain a curing agent.

3. A process according to claim 1, wherein the first ink or coating composition contains a repellant.

4. A process according to claim 1, wherein the pore pattern layer is heat dried.

5. A process according to claim 1, wherein the pore pattern layer is dried in an oven; or wherein the pore pattern layer is dried using infra-red radiation.

6. (canceled)

7. A process according to claim 1, wherein the pore pattern layer is not energy cured.

8. A process according to claim 1, wherein the pore pattern layer is dried to a touch-dry condition; and/or wherein the pore pattern layer is dried to a tack-free finish.

9. (canceled)

10. A process according to claim 1, wherein the topcoat layer is heat dried.

11. A process according to claim 1, wherein the topcoat layer is dried in an oven; or wherein the topcoat layer is dried using infra-red radiation.

12. (canceled)

13. A process according to claim 1, wherein the topcoat layer is not energy cured.

14. A process according to claim 1, wherein the topcoat layer is dried to a touch-dry condition; and/or wherein the topcoat layer is dried to a tack-free finish.

15. (canceled)

16. A process according to claim 1, wherein prior to printing the pore pattern layer onto the substrate a printed design layer is printed thereon and the pore pattern layer is printed onto the printed design layer.

17. A process according to claim 16, wherein the printed design layer is water-based, solvent-based, a hot-melt, a powder and/or energy-curing.

18. A process according to claim 16, wherein the printed design layer is dried prior to the pore pattern layer being printed thereon.

19. A process according to claim 16, wherein the printed design layer imitates the grain of wood.

20. A process according to claim 1, comprising applying a third ink or coating composition onto the dried topcoat layer.

21. A process according to claim 20, wherein the third ink or coating composition is water based, solvent-based, a hot-melt, a powder and/or energy-curing.

22. A process according to claim 1, wherein the printed substrate is energy cured using electron beam radiation; or wherein the printed substrate is energy cured using actinic radiation.

23. (canceled)

24. A process according to claim 1, wherein the substrate is in a sheet or web form; and/or wherein the substrate is paper, a nonwoven or woven fabric or a plastic filmic material.

25. (canceled)

26. (canceled)

27. A process according to claim 24, wherein the substrate is black iron oxide paper.

28. A process according to claim 1, wherein the water-based inks or coating compositions are water-dispersible or water-soluble.

29. A process according to claim 1, wherein the first ink or coating composition and/or the second ink or coating composition comprises a resin.

30. A process according to claim 1, wherein the first ink or coating composition and/or the second ink or coating composition comprises a resin having at least one cross-linkable ethylenically unsaturated group.

31. A process according to claim 30, wherein the resin is selected from the group consisting of polyurethanes, polyurethane-polyureas, polyesters, polyamides, polyester-epoxies, epoxies, acrylics, methacrylics, styrenics, copolymers of styrene and maleic anhydride, polyvinyl alcohol, polyvinyl acetate, polyvinyl chloride copolymers, cellulosics, and combinations thereof.

32. A process according to claim 1, wherein the first ink or coating composition and/or the second ink or coating composition comprises an aqueous polyurethane dispersion.

33. A process according to claim 29, wherein the first ink or coating composition and/or the second ink or coating composition contains between 80 to 98 wt % resin.

34. A process according to claim 1, wherein the repellant is a surface tension modifying additive.

35. A process according to claim 34, wherein the surface tension modifying additive is selected from a group consisting of silicones, waxes, and fluorocarbon polymers.

36. A process according to claim 1, wherein the repellant comprises at least one a paraffinic wax and/or a naturally-occurring wax.

37. A process according to claim 1, wherein the first ink or coating composition and/or second ink or coating composition contain a wax.

38. A process according to claim 37, wherein the first ink or coating composition wax contains a paraffin wax and/or natural wax; and/or wherein the second ink comprises a polyethylene and/or a polytetrafuoroethylene (PTFE) wax.

39. (canceled)

40. A process according to claim 1, wherein the first ink or coating composition and/or the second ink or coating composition contains between 2 to 20 wt % repellant.

41. A process according to claim 1, wherein the first ink or coating composition and/or the second ink or coating composition further comprises a defoamer.

42. A process according to claim 1, wherein the first ink or coating composition and/or the second ink or coating composition is colored, transparent and/or translucent.

43. A process according to claim 1, wherein the substrate, the dried printed design layer, the dried pore pattern layer and/or the dried topcoat layer have a surface energy of between 24 to 54 dynes/sq. cm.

44. A process according to claim 1, wherein the surface tension of the printing ink or coating composition used to provide the printed design layer, the pore pattern layer and the topcoat layer is within + or −5 dynes/sq. cm of the surface energy of the dried underlying layer or substrate.

45. A process according to claim 1, wherein the ink or coating compositions are applied by a coating or printing process selected from the group consisting of flexography, gravure, roll coating, reverse roll coating, anilox, lithography, spray coating, powder coating, electrodeposition, hot melt, screen printing, pad printing, tampon printing, xerography, elcography, ink jet, dip coating, cascade coating, slot coating, air knife coating, curtain coating and trough coating.

46. (canceled)

47. A decorated article produced by a process according to claim 1.

48. A decorated article according to claim 47, wherein the article is decorated paper or paper laminate.
